(19) United States
(12) Patent Application Publication
(10) Pub. No.: US 2008/0133269 A1
(43) Pub. Date: Jun. 5, 2008

(54) Apparatus and methods for collecting, sharing, managing and analyzing data

(76) Inventor: Peter N. Ching, Cowan Heights, CA (US)

Correspondence Address: Robert F. Gazdzinski, Suite 375, 11440 West Bernardo Court, San Diego, CA, 92127, US

(21) Appl. No.: 11/982,150

(22) Filed: Oct. 31, 2007

Related U.S. Application Data
(60) Provisional application No. 60/855,823, filed on Oct. 31, 2006.

(51) Int. Cl. G06Q 50/00

(52) U.S. Cl. 705/2

(57) ABSTRACT

Apparatus and methods for collecting, managing and analyzing data having a related focus, point of tangency or theme, and sharing that information between multiple entities. In one embodiment, the improvements are applied in the healthcare industry including, inter alia, healthcare product and service providers such as doctors, hospitals, pharmacies and labs, consumers/patients, risk management entities, and employers of the patients. By acting as a central repository of synchronized data, an exemplary “patient module provides enhanced capabilities including patient-centric data capture, aggregation and analysis. The patient-centric system disclosed herein integrates the ability to exchange data in electronic formats between disparate data silos with the ability to leverage online and offline data storage and analysis tools to analyze and further share the exchanged data, thereby enabling users to perform sophisticated data analysis on the data and addressing a number of the shortcomings of existing technology.

### PRIORITY

This application claims priority to U.S. provisional patent application Ser. No. 60/855,823 filed Oct. 31, 2006 of the same title, which is incorporated herein by reference in its entirety,

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### 1. FIELD OF THE INVENTION

This invention relates generally to apparatus and methods for collecting, managing and analyzing data having a related focus, point of tangency, or theme (including, without limitation, healthcare and healthcare expenditure related information), and sharing that information between multiple entities.

### 2. DESCRIPTION OF THE RELATED TECHNOLOGY

Optimizing the efficiency and effectiveness of information sharing in many fields of endeavor often requires a significant amount of coordination and complex interactions between multiple entities. For example, in the field of healthcare, the delivery of services often requires coordination between a complex web of parties including Providers, Payors, Employers and Patients. Exchanges of data and information (“Data”), such as e.g., healthcare and healthcare expenditure related information, between the different Participants in conjunction with these healthcare services is a necessary aspect of this coordination. The current topology for Data sharing consists of silos of Data (“Data Silos”) maintained and exchanged between the Data Silos through a mix of paper based and electronic Data exchange based methods. Efforts have been underway for some time to replace paper based Data exchange workflows with workflows based on exchanges of electronic Data.

For example, U.S. Pat. No. 6,826,535 to Wood, et al., issued Nov. 30, 2004 and entitled “Method for reducing fraud in healthcare programs using a smart card” discloses a method for reducing fraud in a healthcare program by registering a service provider with a private healthcare provider and issuing a service provider identification codes, registering at least one service of the service provider with the private healthcare provider and identifying a claim code for each registered service; issuing a smart card to an individual related to a benefits program of the private healthcare provider wherein the individual has an identification code and the smart card has a feature to identify the individual; using the smart card to determine if the individual is the authorized card bearer and is eligible for the healthcare program; using the smart card to determine if a service provider is preauthorized to provide a registered product under the private healthcare provider program; and using the smart card to facilitate a transmission between the service provider and the private healthcare provider. A salient disadvantage of the '535 patent is that it does not provide a means whereby the patient, as Purchaser, can capture Specific Transaction Data or Information from the service provider, as Vendor. It should also be noted that a further disadvantage of the '535 patent is that it relies on integrated circuit or magnetic strip based Smart Cards which are limited both in terms of the amount of information they can store and, in the case of integrated circuit Smart Cards, by the limited availability of compatible data reading and writing devices in the U.S. market (thereby excluding more readily available portable data transport and storage mediums such as USB flash keys and Personal Digital Assistants).

Efforts to replace paper based Data exchange workflows with workflows based on exchanges of electronic Data have predominantly focused on electronic exchanges between Providers and Payors (as above) or between Providers in a network.

For example, U.S. Pat. No. 6,775,670 to Bessette issued Aug. 10, 2004 and entitled “Method and apparatus for the management of data files” discloses a network system for storage of medical records. The records are stored in a database on a server (or alternatively on a Smart Card). Each record includes two main parts, namely a collection of data elements containing information of medical nature for the certain individual, and a plurality of pointers providing addresses or remote locations where reside other medical data for that particular individual. Each record also includes a data element indicative of the basic type of medical data found at the location pointed Lo by a particular pointer. This arrangement permits a client workstation to download the record along with the set of pointers which link the client Lo the remotely stored files. The identification of the basic type of information that each pointer points to allows the physician to select the ones of interest and thus avoid downloading massive amounts of data where only part of that data is needed at that time. In addition, this record structure allows statistical queries to be effected without the necessity of accessing the data behind the pointers. For instance, a query can be built based on keys, one of which is the type of data that a pointer points to. The query can thus be performed solely on the basis of the pointers and the remaining information held in the record. A disadvantage of this system is that although provision is made to allow medical records to be located based on information contained on the Smart Card, the information stored on the Smart Card is insufficiently secured from disclosure to or use by unauthorized parties. Further, the '670 patent provides neither a means whereby the individual's information can be authenticated as being from a trusted provider of data, nor a means whereby the individual's information can be validated as being in the form in which it was originally issued (i.e., being free from error, truncation or modification).

U.S. Pat. No. 7,225,408 to O'Rourke issued May 29, 2007 and entitled “System and user interface for communicating and processing patient record information” discloses a system which facilitates the secure access, transfer and update of patient record information and the creation and navigation of image menus supporting the location and access of desired patient record data by a user. A system provides a user interface for use by a portable processing device for accessing and navigating patient record information. The system receives user identification information for use in authorizing user operation of the portable processing device and initiates display of an image including a plurality of links to a corresponding plurality of individual patients. The system also initiates display of a patient record content index image including a plurality of links to a corresponding plurality of items of patient record information in response to user selection of a link to one of the plurality of individual patients. The system further initiates display of an image including information comprising a portion of a patient record in response to user selection of a link to one of the plurality of items of patient record information.

Attempts to utilize a network of computer terminals in communication with each other represents another effort to utilize electronic (rather than paper) Data exchanges between Providers or between Providers and Payors. For example U.S. Pat. No. 6,012,035 to Freeman, Jr., et al. issued Jan. 4, 2000 and entitled “System and method for supporting delivery of health care”; which discloses the effectuation of a health care provision agency cooperative function established through a communication network linking all the various entities of the cooperative. The entities include the third party payor members, the health providing individuals, clinics, or the like, along with secondary providers including pharmacies and laboratories, health care facilities such as hospitals, and the several entities associated with management of the cooperative and appropriate funds transfer functions. A coordinating interface system maintains data storage of the necessary information, and manages the entity intercommunications in accordance with the basic structure of the active and eligible elements of the agency cooperative.

U.S. Pat. No. 7,286,997 to Spector, et al. issued Oct. 23, 2007 and entitled “Internet-based, customizable clinical information system” discloses an Internet-based, or Web-based, customizable clinical (patients' records and care) information system (“CIS”). More specifically, the clinical information system is Web/Internet based, whether it utilizes a browser-type user interface or a distributed application-type user interface; the clinical information system may include automatic disease staging and associated treatment planning and/or scheduling; the clinical information system may track certain events/submissions and sort such events/submissions into a physician's in-box for on-line approval by the physician, where such approval causes the event/submission to become an addendum to the patient's record; the clinical information system may be customizable by an administrator; the clinical information system may establish, and make available for on-line review and approval, patient care or standing orders over a weekend; the clinical information system may utilize patients' photographs to ensure accurate identification and proper treatment; and the clinical information system may create and store an audit trail record for all significant events.

However, to the extent Patients wish to exchange Data with Payors and Providers, the options available are generally paper based and to the extent the exchanges of Data are electronic, the exchanges generally involve manual entry of Data into Provider and Payor databases through web based interfaces and generally do not provide mechanisms whereby Patients can capture the Data without having to reenter the Data manually, creating a significant amount of work for the Patients, Providers and Payors and creating a significant risk of data entry related errors in the entered Data.

In the context of Patient healthcare, where currently Participants such as Providers, Payors and Employers play prominent roles in determining how and when healthcare is delivered to Patients, increasingly, authority for decisions about how and when healthcare dollars are spent is being shifted to Patients through consumer driven healthcare initiatives. With this delegation comes the responsibility of weighing ever increasingly complex factors including cost, effectiveness and appropriateness of care for a specific patient based on the specifics of that particular patient's circumstances and condition. As the authority and responsibility for healthcare spending is being shifted to Patients, there arises a need for decision support tools that provide Patients with the ability to capture and analyze their Data using analytical tools that will enable the Patients to make decisions that optimize desirable characteristics.

Centralized repositories of data and decision support tools analyzing integrated or distributed assemblages of data have been employed to optimize planning decisions. (See '670 patent to Bessette, '408 patent to O'Rourke, '035 patent to Freeman, and '997 patent to Spector above.) However, current art data and decision support tools available for patient use are generally focused on a certain subset of the total Data Patients need to analyze (generally either the financial transaction aspect or the health information aspect but not both) or require that Patients enter large amounts of Data manually. Further, applying these types of support tools and techniques in the context of supporting Patient decision making has been problematic because exchanges between Providers and Patients and between Payors and Patients have predominantly focused on enabling Patients to view (as opposed to capture) Data maintained electronically in Provider and Payor databases.

As a result, Data for a single individual is typically distributed across multiple distinct Participant data silos. The uncoordinated nature of the Data distribution and the attendant fragmentation of the Patient's Data greatly complicate Patients' ability to develop an integrated view of their Data and to analyze their Data in an integrated manner.

What is needed is a means for Patients to electronically capture their Patient Data from other Participant's data silos directly into an integrated repository that enables them to analyze their Patient Data in an integrated fashion. The electronic Data captured ideally should be secured from disclosure to or use by unauthorized parties. Further, the Data capture mechanism would also advantageously employ mechanisms to ensure authentication of an individual's Patient Data as being from a trusted provider of Data and ensure verification that the Patient Data has not been modified or altered.

### SUMMARY OF THE INVENTION

The foregoing needs are satisfied by the present invention which discloses, inter alia, methods and apparatus for collecting, sharing, managing and analyzing data.

In a first aspect of the invention, a method analyzing healthcare-related data in support of patient decision-making and optimization is disclosed. In one embodiment, the method comprises entering the healthcare-related data into a data collection entity, securely storing an electronic copy of the data on the data collection entity, and providing a method for the retrieval and display of the data.

In one variant, the healthcare-related data is entered manually via a user interface. The user interface may be located on the data collection entity itself, or alternatively on a separate entity with which the data collection entity is in (either wired or wireless) communication.

In a second variant, the healthcare-related data is entered into the data collection entity by communication with a healthcare-related data measuring device. Communication with such a device may be either via wired communication or may be wirelessly accomplished.

In another variant, the data collection entity comprises a portable storage device. The portable storage device may be, but is not limited to, personal digital assistants (“PDAs”), cell phones, IC based smart cards, USB flash memory keys, Secure Digital (SD) cards, PDAs, and compact flash cards. In another embodiment, the data collection entity is the hard disk drive of a healthcare professional maintained terminal. In yet another variant, the data collection entity is a data silo. The healthcare-related data may be retrieved according to this aspect of the invention by direct communication with the data silo. Alternatively, in still another variant, the data held by the data silo may be accessed via use of a remote server which communicates between the requesting entity and the data silo.

In yet another variant, the health-care related data is comprised of patient-specific healthcare-related data, and healthcare benchmark information (or health metrics data) determined by a healthcare professional. The healthcare benchmark information (or health metrics data) in this variant is utilized for comparison to the patient-specific healthcare-related data.

In a further variant, the healthcare-related data is permitted to be securely sent to a remote entity via a secure connection to selected recipients. The method of this variant enables a user to share the healthcare-related data with selected recipients using secure data transfer methodologies and data transfer means that include but are not limited to portable storage media and devices, email and dedicated secure message servers.

In a second aspect of the invention, a computer-readable media, comprising a storage medium adapted to store a computer program on it is disclosed. In one embodiment, the computer program may be adapted to run on a portable storage device (such as a PDA or cell phone) or may be adapted run on a home or laptop computer which is designed to accept the portable storage device on which the healthcare-related data is stored. The computer program (user software) is adapted to enable a user to acquire, store, and view the healthcare-related data. Additional functions within the software enable the user to characterize and analyze the healthcare-related data and add additional informational elements to the data.

In one variant, the computer program is also adapted to enable a user to maintain a secure connection with a remote entity thus enabling the secure transmission of healthcare-related data. Accordingly, the user software is adapted to retrieve healthcare-related data from a remote entity via a secure connection. (Healthcare related data may also be manually entered into the user software via a user interface.) Further, the user software is adapted to send or transmit the data to a remote entity via a secure connection.

In another variant, the software also enables the user to combine the healthcare-related data acquired from a first entity with additional external data acquired from a second entity and to use analytical tools to analyze the data from the various entities and to model outcomes of decisions in a variety of contexts.

In yet another variant, the location and nature of the remote entity (e.g. a data silo) can be recorded in a database, that record can be utilized to enable a user to request and receive subsequent updates to the healthcare-related data. The updated, or new data, may then be captured and integrated into the data previously stored in the software.

In still another variant, user software is adapted to enable a user to manually enter healthcare-related data into a user interface. For example, the user interface may implement dynamic color coding to alert the user to the presence of mandatory fields.

In yet another variant, the software utilized by the user provides the user with the ability to distinct types of healthcare related data. The user receives at least one set of patient-specific healthcare-related data and at least one set of healthcare benchmark information (or health metrics data). The user may share the healthcare benchmark information (or health metrics data). The user may also display said healthcare benchmark information (or health metrics data) against other healthcare benchmark information (or health metrics data) and/or against his specific healthcare-related data.

In another variant, the computer program enables the user to display the distinct types of healthcare-related data against one another on a single display incorporating a common scale of measurement. This provides the user with inter alia the ability to visualize the relationship between differing health metrics and track his progress in relation to healthcare benchmarks.

In a third aspect of the invention, an apparatus for capturing and securely storing data is disclosed. In one embodiment, the data comprises healthcare-related data that may be used to facilitate analysis, patient decision-making and optimization. The portable storage device, which can be utilized to capture the healthcare-related data in electronic format, may include, but is not limited to, personal digital assistants (“PDAs”), cell phones, IC based smart cards, USB flash memory keys, Secure Digital (SD) cards, PDAs, and compact flash cards. The portable storage apparatus is comprised of a security element adapted to disallow unauthorized access to the data, and a receiving element adapted to capture the healthcare-related data and authenticate it as being from a trusted provider and unmodified. The portable storage apparatus also may comprise a storage element adapted to record the healthcare-related data and a communication element adapted to establish secure communication with a remote entity.

In one variant, the remote entity comprises a data silo; the portable storage device directly accesses the data stored in the data silo. In another variant, the remote entity is a remote server, and, as discussed above, a connection to a remote server will permit the portable storage device to access a data silo. In yet another variant, the remote entity is a medical professional maintained terminal. Thus, a patient may receive healthcare-related data from his directly from medical provider. A patient may also submit data to his medical provider as well.

In another embodiment, the remote entity with which the portable storage device may be in communication with may be a home or laptop computer on which a healthcare-related data analysis program is run. The computer program (user software) is adapted to retrieve the healthcare-related data stored on the portable storage device, and enable a user to view and analyze the data.

In another embodiment, the portable storage apparatus comprises a USB flash key which is adapted to be inserted into a USB port of a remote entity.

In another embodiment, the portable storage device is further comprised of a hard disk drive element which is adapted to run a computer program; the computer program will enable a user to analyze the healthcare-related data (such as in the one discussed above). The portable storage device of this embodiment also may comprise a display element, enabling the display of the stored healthcare-related data, and a user interface. The user interface will permit the user to manually enter healthcare-related data at his option, and will permit the user to analyze the data via the analysis tools available on the aforementioned computer program running on the portable storage apparatus.

In another embodiment, the communication element of the portable storage apparatus comprises the components necessary for wireless communication with a remote entity. The remote entity may include, but is not limited to a data silo, home computer, or laptop computer.

In a fourth aspect of the invention, a healthcare professional maintained terminal is disclosed. In one embodiment, the terminal is comprised of a security element to disallow unauthorized access, a receiving element which will receive healthcare related data and authenticate the data as being from a trusted source and unmodified. The terminal may also be comprised of a hard disk drive element which will be adapted to record the healthcare-related data and run a computer program by which a user will be able to analyze the data. The terminal may also be comprised of a display element to allow for viewing of the healthcare-related data, a user interface to permit a user to utilize analysis tools to analyze said healthcare-related data, and a communication element to provide for secure transmission of information from the terminal to a remote entity.

In one variant, the remote entity with which the healthcare professional maintained terminal is in secure communication with comprises a data silo. Thus, a healthcare professional may receive or send information directly to the data silo. In another variant of this embodiment, communication between the data silo and terminal occurs through a remote server.

In another embodiment, the remote entity with which the healthcare professional maintained terminal is in secure communication with comprises a remote server adapted to communicate with at least one data silo. In one variant, the healthcare-related data comprises patient insurance information. The terminal communicates the patient insurance information to an insurance data silo via its connection to the remote server. The insurance data silo communicates a verification of the patient insurance information to the terminal via the same connection to the remote server. In another variant, the terminal maintains the patient insurance information and the verification of that information. This enables the terminal to inter alia subsequently communicate the patient insurance information and verification to other entities including, for example, other physician's terminals, office billing software, etc.

In another embodiment, the remote entity with which the healthcare professional maintained terminal is in secure communication with comprises a portable storage device. This permits a patient to receive and/or send healthcare-related data to and from his healthcare professional. In one variant of this embodiment, the terminal is adapted to request patient-specific healthcare-related data from the patient's portable storage device. The patient may respond to the request, and the terminal is adapted to receive that response and subsequently process it. In one variant, the data requested comprises an appointment confirmation sent to a patient. The terminal processes the patient's response by recording the status of the appointment.

In another variant, the data requested comprises patient insurance information. The terminal processes the patient's response by verifying the insurance information as discussed above.

In a fifth aspect of the invention, a system for the secure transmission and storage of healthcare-related data in a healthcare environment is disclosed. In one embodiment, the system comprises a remote entity which maintains the healthcare-related data and at least one portable storage device adapted to communicate with the remote entity in order to receive, store and securely transmit healthcare-related data.

In one variant, the portable storage device communicates with the remote entity via a secure wireless connection. The remote entity with which the at least one portable storage device is in wireless communication with may comprise for example a data silo. The at least one portable storage device is accordingly adapted to receive data from the data silo via a secure connection thereto. In another variant, the portable storage device communicates with the data silo via routing from a remote server.

In another embodiment, the remote entity comprises a healthcare professional maintained terminal. According to this embodiment, a doctor or other healthcare provider can enter healthcare-related data; this may be accomplished manually via e.g., a user interface or digitally via medical equipment in communication with the doctor's terminal. The portable storage device then communicates directly with the healthcare provider maintained terminal to access, retrieve, and store the healthcare-related data. In another embodiment, the remote entity comprises a data silo. The healthcare provider generated healthcare-related data is sent to the data silo server using a variety of connection methods tailored to the unique connectivity requirements of the target data silo. The portable storage device then communicates with the data silo to access, retrieve and store the healthcare-related data via a secure connection.

In a sixth aspect, a method of doing business is disclosed. In one embodiment, the method is used within a healthcare environment. The method comprises making healthcare-related data available to a patient and enabling a patient to utilize a portable storage device adapted to receive, store, and analyze the healthcare-related data.

In one variant, the data is made available to a patient by permitting the patient to access a remote entity containing the healthcare-related data, and the remote entity comprises a data silo. Connection to the data silo may be either direct, or, in another variant, may be accomplished via a remote server.

In yet another variant, the remote entity is a healthcare professional maintained terminal as discussed above.

### BRIEF DESCRIPTION OF THE DRAWINGS

The above and other features and advantages of the present invention are hereinafter described in the following detailed description of illustrative embodiments to be read in conjunction with the accompanying drawings and figures, wherein like reference numerals are used to identify the same of similar system parts and/or method steps, and:

FIG. 1 is a depiction of a partial list of Participants from the Patient's Perspective.

FIG. 2 is a diagram illustrating an exemplary flow of the Data exchange between a Patient and other Participants from the Patient's perspective.

FIG. 3 is a flowchart of one embodiment of a method of recording Patient data to an electronic file, transferring the Patient data to a Doctor using a variety of transfer methods, using that Patient data to conduct a Patient insurance eligibility check and storing the Patient data and the results of the insurance eligibility check.

FIG. 4 is an exemplary screenshot of one embodiment of a software application conforming to the third aspect of the instant invention.

FIG. 5 is an exemplary screenshot of one embodiment of a software application conforming to the fourth aspect of the instant invention.

FIG. 6 is a graphical representation of an exemplary remote server configuration.

### DETAILED DESCRIPTION OF THE INVENTION

The following descriptions are exemplary embodiments of the invention disclosed herein and are not intended to limit the scope, applicability or configuration of the invention in any way. Rather, the following description is intended to provide convenient illustrations for implementing various embodiments of the invention. It will be appreciated by one skilled in the art that various additions, substitutions or deletions may be made in the function and arrangement of the elements described in these embodiments (as well as the sequence and content of steps described herein) to ascertain and/or realize any number of other benefits without departing from the spirit and scope of the instant invention.

It will be further understood by one skilled in the art, that while the exemplary embodiment disclosed below contemplates execution of programs and storage of information using a combination of Sender and Destination computers and a transfer device, the specific platform assigned to executing a particular program and sub-function thereof maybe changed, added to or reduced without departing from the spirit and scope of the instant invention.

Further, one skilled in the art will also realize that alternate storage, processing and transport modes, including but not limited to e-mail, personal digital assistants, cellular phones and Bluetooth, WiMax, PAN, RFID, TCP/IP and WiFi based devices may alternatively be substituted for various elements of the system disclosed herein without departing from the spirit and scope of the instant invention.

As used herein, the terms “computer program” and “software” are meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VOXML), and the like, as well as object-oriented environments such as the Common Object Request Broker Architecture (CORBA), Java™ (including J2ME, Java Beans, etc.) and the like.

### Overview

In one salient aspect, the present invention relates generally to systems and methods for collecting, managing and analyzing data having a related focus, point of tangency or theme (including, without limitation, healthcare and healthcare expenditure related information), and sharing that information between multiple entities.

In one embodiment, the improvements are applied in the healthcare industry including, inter alia, healthcare product and service providers such as doctors, hospitals, pharmacies and labs (“Providers”), consumers (“Patients”), risk management entities (“Payors”) and employers of the Patients (“Employers”) (collectively “Participants”). More specifically, one aspect of the invention relates to methods and systems of centralizing and analyzing Patient healthcare and healthcare expenditure related data in support of Patient decision making and results optimization.

By acting as a central repository of synchronized data, an exemplary “Patient Module”, working in conjunction with various means of capturing data, provides patient-centric data capture, aggregation and analysis capability that contrasts with current-art patient side systems. The Patient-centric system for capturing and analyzing Patient Data disclosed herein integrates the ability to exchange Data in electronic formats between disparate data collection entities (including inter alia, Data silos, and physician maintained data terminals) with the ability to leverage online and offline data storage and analysis tools to analyze and further share the exchanged Data, thereby enabling users to perform sophisticated data analysis on the Data and addressing a number of the shortcomings described in the above discussion of related technology.

In another aspect, an exemplary “Doctor Module” is also provided. This module is adapted to work in conjunction with the various apparatus for capturing data discussed above, and provides a healthcare professional (e.g. a doctor, dentist, pharmacist, or similar person) with aggregated Patient Data for analysis and expedited case management. The exemplary Doctor Module also enables the medical professional to add, amend, store and delete Patient Data. Patient Data may also be securely exchanged with other entities (including, inter alia, billing software within the healthcare professional's office, patients, risk management entities, other healthcare providers, and employers) via the Doctor Module. According to this model, provision of healthcare services will be efficient and will incorporate communication between the various healthcare professionals and patients.

### EXEMPLARY EMBODIMENTS

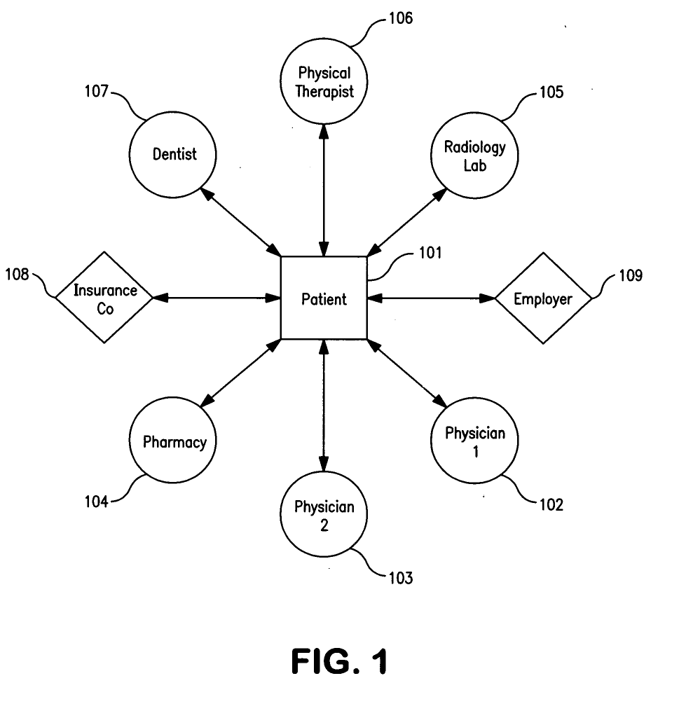

In FIG. 1, the diagram illustrates an exemplary distribution of Participants from the Patient's perspective. In the course of receiving healthcare services, the Patient 101 exchanges Data with a first physician (“Physician 1”) 102, a second physician (“Physician 2”) 103, a pharmacy 104, a radiology lab 105, a physical therapist 106 and a dentist 107. In addition, in conjunction with their receiving healthcare services from the aforementioned Participants, the Patient 101 also exchanges Data with their healthcare insurer 108 and their employer 109.

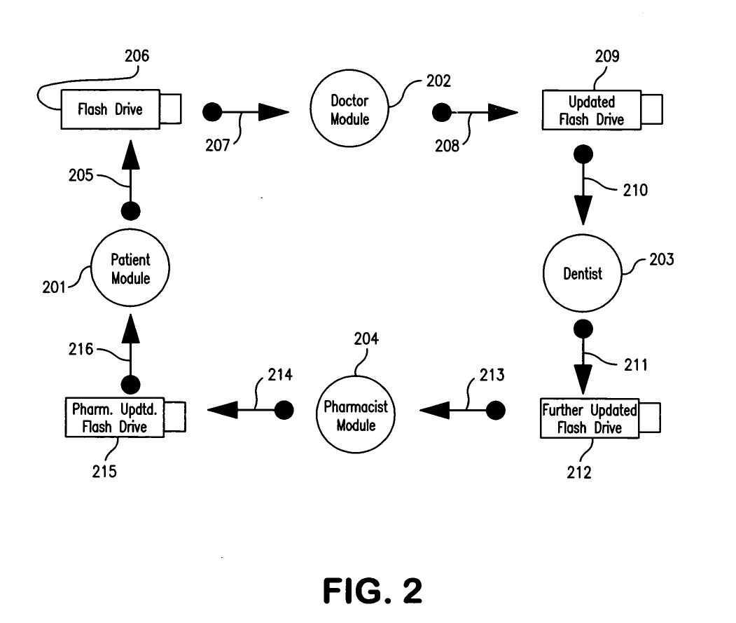

In FIG. 2, the diagram illustrates an exemplary flow of the Data exchange between a Patient 201 and other Participants from the Patient's 201 perspective. In the exemplary scenario, the Patient 201 has appointments with a Physician 202, a Dentist 203 and a Pharmacy 204. For purposes of this teaching, the presumed order of appointments is Physician 202 then Dentist 203 then Pharmacy 204 but it will be readily apparent to one skilled in the art that the specific sequence of Data exchange as among Participants may be changed without department from the principles taught herein.

Prior to attending the first appointment, the Patient enters Data (not shown) into a software application executing on a personal computer (the “Patient Module”) 201. It will be noted however, that the Patient Module may alternatively comprise a system wherein the software application is executed on a personal storage device capable of running the program (such as, for example, a PDA, cell phone, smartphone, or the like). The Patient Module 201 incorporates, inter alia, algorithms capable of storing the Data in an encrypted file (a “Patient Information File” or “PIF”) (not shown) that can be amended to add new Data or amend or delete Data already entered into the PIF. The PIF is also structured in a manner that allows the Data to either be segmented into one or more sections each corresponding to an individual user's set of Data or, if desired, as one consolidated set of data (for example in cases in which it is desirable to consolidate an entire family's Data in one PIF). To transfer the Data, the User utilizes functionality in the Patient Module 201 to designate Data for storage in a PIF. The Patient Module then stores the selected Data in the encrypted PIF.

The User is then prompted to designate a transfer method. The transfer method may include either wired or wireless transfer including through email or other entity utilizing secure Internet connections. The wired transfer of the Data in the encrypted PIF may also be accomplished by placing the information on a personal storage device including, inter alia, a PDA, cell phone, IC based smart card, Secure Digital (SD) card, compact flash card, or USB flash memory key. In the example of FIG. 2, the User selects USB Flash Key (the “Flash Drive”) as the transfer method. The Patient Module 201 then transfers (step 205) the PIF to the Flash Drive 206. More than one PIF can be stored on the Flash Drive 206. The Flash Drive 206 may, as required, incorporate separate encryption algorithms to secure the PIF from unauthorized access. To this end, it will be recognized that the methods and apparatus disclosed in co-pending U.S. patent application Ser. No. 11/588,614 filed Oct. 26, 2006 entitled “METHOD AND APPARATUS FOR SECURE DATA TRANSFER”, which claims priority to U.S. Provisional Patent Application Ser. No. 60/731,087 filed Oct. 28, 2005 of the same title, each of the foregoing incorporated herein by reference in its entirety, may be used consistent with the present invention for transferring data from one device or domain to another.

The User then transports the Flash Drive 206 containing the PIF to the Physician's office. At the Physician's office, the Flash Drive 206 is connected (step 207) to a personal computer equipped with software designed to interact with the PIF and Flash Drive (a “Doctor Module”) 202 via the computer's USB port (not shown). It will be appreciated that use of a USB port represents only one method of wired communication with the Doctor Module. Other data interfaces and/or personal storage devices may also be utilized, including for example FireWire (IEEE-1394) interfaces and devices, wireless interfaces and devices (e.g., IEEE Std. 802.11, Bluetooth, RFID, IEEE Std 802.15, IEEE Std 802.16, IEEE Std 802.20, etc.), and so forth. The Doctor Module 202 incorporates functionality enabling the user of the Doctor Module (the “Staff”) to add, amend or delete Data in the PIF. The Doctor Module 206 also incorporates functionality enabling the Staff to exchange Data between the Doctor Module 206 and other software applications in the Physicians office (not shown) and other healthcare professionals' offices (not shown).

The Staff accesses (step 207) the PIF on the Flash Drive 206 through functionality in the Doctor Module 202 that enables the Staff to designate which PIF the Doctor Module 202 should read Data from. The Doctor Module 202 then reads the Data on the selected PIF. The information read from the PIF can include but is not limited to information added to or amended in the PIF by other healthcare providers, the User's health insurance billing information, contact and other necessary personal information and health history information. The Staff updates the selected Data using the functionality in the Doctor Module 202 to add new Data to the PIF and also to modify or delete (as required) Data already in the PIF (step 208). These changes can reflect changes to Data in the PIF that include but are not limited to treatments provided, medications prescribed, the User's insurance billing information and diagnosis and treatment instructions provided by the Physician. Alternatively, if a connection to the PIF is not available at the time the Staff is ready to write changes to the PIF or if the Staff requires access to multiple PIFs stored on multiple Flash Drives (not shown), the Doctor Module 202 incorporates the ability to store changes to Data associated with a specific PIF in a temporary cache and synchronize the changes to the designated PIF at a later time. Alternatively, the Doctor Module 202 enables the Staff to make a copy of the User's PIF for subsequent use (the “Physician's PIF Copy”) (not shown), regardless of whether access to the copy of the User's PIF on the Flash Drive 206 is available and to repeatedly synchronize the Data in the Physician's PIF Copy with the PIF on the Flash Drive 206. Further, optionally included within the exemplary Doctor Module above, is a security function whereby the additions, modifications and deletions to the Patient Data made by a healthcare professional cannot be altered (i.e. undone) by unauthorized persons. Accordingly a physician's entry cannot be “faked” by someone who is not the stated physician; nor can the physician's entry be removed or altered and replaced by anyone other than the physician himself. This may be accomplished, for example, by separating data entered by in a Doctor's Module into a read-only file while viewed in the Patient's Module. The patent will only be permitted to copy this data for importation into the analysis portion of the user interface and will not be permitted to alter the section of the data placed into the system by the Doctor's Module.

After the PIF is updated, the User then proceeds to their appointment with the Dentist carrying the Flash Drive 209 containing the updated PIF. At the Dentist's office, the Dentist's staff uses an instance of the Doctor Module (the “Dentist Module”) 203 to read information from the updated PIF (step 210) and to add new Data or modify or delete (step 211) Data already existing in the PIF on the Flash Drive 209. The Dentist Module 203 may be the same version as the one utilized by the Physician's staff or may be an alternate version incorporating features and functions adapted to the needs of the Dentist's staff. The information read from the PIF can include but is not limited to information added to or amended in the PIF by other healthcare providers, the User's health insurance billing information, contact and other necessary personal information and health history information. Changes written by the Dentist Module 203 can reflect changes to Data in the PIF that include but are not limited to treatments provided, medications prescribed, the User's insurance billing information and diagnosis and treatment instructions provided by the Dentist. If required, the Dentist Module 203 can incorporate the ability to store changes to Data associated with a specific PIF in a temporary cache and synchronize the changes to the designated PIF at a later time. Alternatively, the Dentist Module 203 provides the Dentist's staff with the ability to make a copy of the PIF for subsequent use (the “Dentist's PIF Copy”), regardless of whether access to the copy of the User's PIF on the Flash Drive 209 is available and to repeatedly synchronize the Data in the Dentist's PIF Copy with the PIF on the Flash Drive 209.

The User then proceeds to the Pharmacy and presents the Flash Drive containing the further updated PIF 212 to the Pharmacist (not shown). At the Pharmacy, the Pharmacist uses an instance of the Doctor Module (the “Pharmacist Module”) 204 to read information from the updated PIF (step 213) and to add new Data or modify or delete (step 214) Data already existing in the PIF on the further updated Flash Drive 212. The Pharmacist Module 204 may be the same version as the one utilized by the Physician's staff or may be an alternate version incorporating features and functions adapted to the needs of the Pharmacist. The information read from the further updated Flash Drive 212 can include but is not limited to information added to or amended in the PIF by other healthcare providers, the User's health insurance billing information, contact and other necessary personal information and health history information. Changes written by the Pharmacist Module 204 can reflect changes to Data in the PIF that include but are not limited to medicines prescribed, insurance billing information and usage instructions associated with medications provided by the Pharmacist. Similarly to the Physician's and Dentist's instances of the Doctor Module, if required, the Pharmacist Module 204 incorporates the ability to store changes to Data associated with a specific PIF in a temporary cache and synchronize the changes to the designated PIF at a later time. Alternatively, the Pharmacist Module 204 provides the capability to make a copy of the PIF for subsequent use (the “Pharmacist's PIF Copy”), regardless of whether access to the copy of the User's PIF on the further updated Flash Drive 212 is available and to repeatedly synchronize the Data in the Pharmacist's PIF Copy with the PIF on the further updated Flash Drive 212.

After receiving Data updates from the Pharmacist (step 214), the User returns home and uses the Patient Module 201 to access the PIF (step 216) on the Pharmacist updated Flash Drive 215. Functionality in the Patient Module 201 enables the User to synchronize any changes in the PIF on the Pharmacist updated Flash Drive 215 with a copy of the PIF maintained on the computer executing the Patient Module 201 or in another User designated location (not shown). Other functionality in the Patient Module 201 enables the User to perform analyses on the Data contained in the PIF on the Pharmacist updated Flash Drive 215, including but not limited to the information incorporated in successively updated PIF copy (not shown) maintained by the Patient Module 201.

It will be apparent to one skilled in the art that a number of variations to the above disclosed teaching can be introduced without materially altering the principles taught herein. For example, the Patient Module 201 installed on the User's personal computer can be replaced with a thin client version utilizing a web browser based user interface to enable the User to enter the data and save information in a software application providing the same functionality as the thick client version of the Patient Module 201 (including but not limited to the ability to store data on a Flash Drive 206 connected to the Users personal computer) but that is executed on a remote server rather than locally on the Users personal computer. Similarly, the locally installed instances of the Doctor Modules may be replaced with thin client interfaces that provide similar functionality to the thick client versions of the Doctor Modules installed locally at the Physician's and Dentist's offices. In addition, while certain providers of services to the User have been identified in this exemplary description, it will be evident to one skilled in the art that other providers and Data types may be substituted without materially changing the principles taught herein. Further, the above described cycle of updating Data on PIFs and synchronizing those changes across multiple copies of the PIF can be repeated or altered as required without regard to the sequencing of Data holders (i.e., physicians, dentists pharmacies, etc.) and can be extended to other Data holders not described in this teaching.

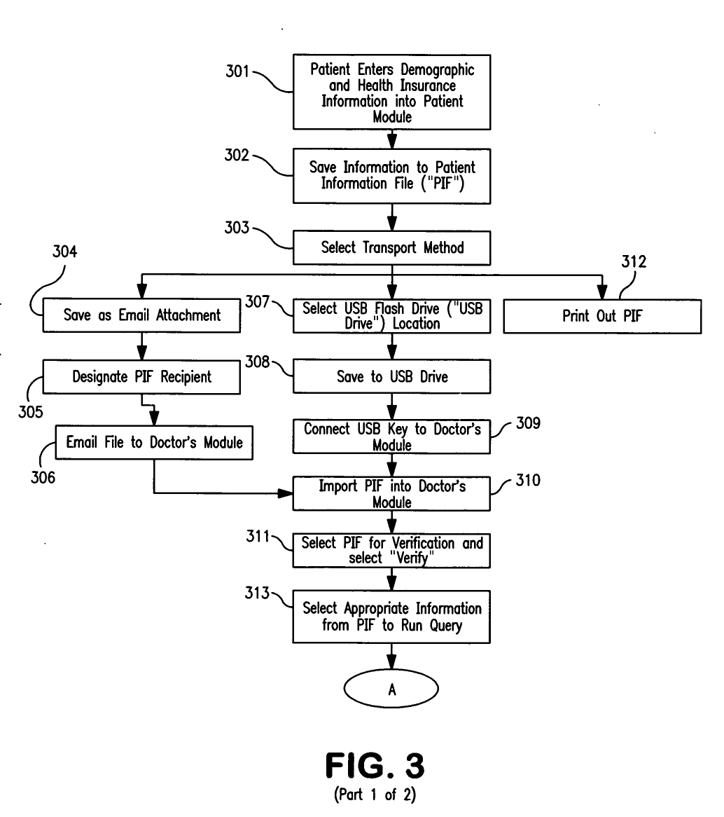

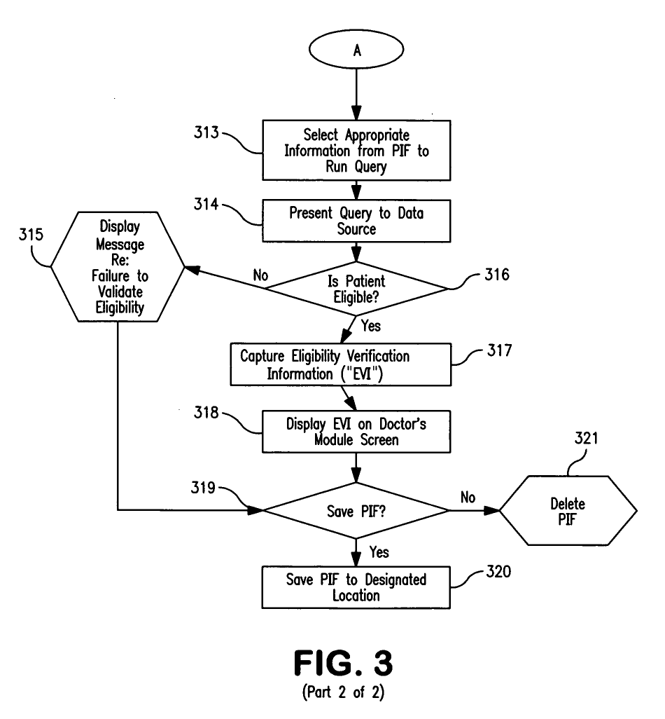

In FIG. 3, the flowchart illustrates a method of recording Patient Data to an electronic file, transferring the Patient Data to a Doctor using for example USB flash drive (or other personal storage device), email, wireless transmission, or hard copy printout based methods, using certain elements of that Patient Data to conduct a Patient insurance eligibility check and storing the Patient Data and the results of the insurance eligibility check on a selected computer or computers. In accordance with an aspect of the present invention, a Patient enters identification information, health information and health insurance billing information into a software application (the “Patient Module”) configured for that purpose (step 301). The Patient Module stores the information into an encrypted data file (“EDF”) (step 302). A method is then selected to transfer the EDF to a designated doctor according to preconfigured settings or through a selection dialogue (step 303).

If the transfer method selected is printing out the EDF, the data in the EDF is then printed out by the Patient Module (step 312) and physically brought (or sent via facsimile or the like) to the physician's office.

If the transfer method selected is email, the EDF is saved as an attachment to an email using an email client or email client functionality built into the Patient Module (step 304), a recipient for the EDF is designated (step 305) and the EDF is transferred via email to the selected recipient's computer, which, in the instant exemplary implementation, is executing a software application (the “Doctor Module”) configured to provide services related to the instant invention (step 306). The EDF is then imported from the email (or the email client as the case may be) into the computer executing the Doctor Module and is loaded in a manner that makes it accessible to the Doctor Module (step 310). From within the Doctor's Module, a user selects the EDF to be verified and selects, “Verify” in the Doctor Module (step 311). The Doctor Module selects information from the designated EDF as necessary to present a query to a verification data source (step 314). Alternatively, the Doctor Module may be configured to submit the query to a remote query server (a “Remote Server”) which will then submit the query in the required format or formats to a verification data source (not shown).

If the transfer method selected is a personal storage device, in this example a USB flash drive (“USB Drive”), the USB Drive attached to the computer executing the Patient Module is selected (step 307) and the EDF is saved to the selected USB Drive (step 308). The USB Drive is subsequently connected to a computer executing a copy of the Doctor Module configured to provide services related to the instant invention (step 309). The EDF is then imported from the USB Drive into the computer executing the Doctor Module and is loaded in a manner that makes it accessible to the Doctor Module (step 310). From within the Doctor's Module, a user selects the EDF to be verified and selects, “Verify” in the Doctor Module (step 311). The Doctor Module selects information from the designated EDF as necessary to present a query to a verification data source (a “Verification Source”) (step 314). Alternatively, the Doctor Module may be configured to submit the query to a remote query server (a “Remote Server”) which will then submit the query in the required format or formats to a Verification Source (not shown).

After the query is submitted to the Verification Source, the Doctor Module awaits the response from the verification data source. If the response is that the Patient represented by the EDF data is not covered by health insurance, the Doctor Module then displays a message alerting the user to this response (step 315). The Doctor Module also asks the user whether they want to save the record of the response and the EDF (step 319). If the user indicates they wish to save the record of the response and the EDF, that information is then saved in a preconfigured or designated location (step 320). If the user indicates they do not wish to save the record of the response and the EDF, that information is then deleted (step 321).

If the response is that the Patient is covered by the health insurance, the Doctor Module then captures the eligibility verification information (“EVI”) from the Verification Source (step 317). The Doctor Module then displays a message alerting the user to this response and the EVI captured from the Verification Source (step 318). The Doctor Module also asks the user whether they want to save the record of the response and the EDF (step 319). If the user indicates they wish to save the record of the response and the EDF, that information is then saved in a preconfigured or designated location (step 320). If the user indicates they do not wish to save the record of the response and the EDF, that information is then deleted (step 321).

The verified data (e.g., insurance data), once saved, may be transmitted to other entities. For example, a patient may approach a doctor regarding a health issue. The patient might submit (via the above described method) insurance information to be verified by the physician's office. After verification that the patient represented by the EDF data is covered by health insurance, the patient receives care. If the physician's office indicates that the record of the response to the insurance verification and the EDF information should be saved, the data will be saved in the Doctor's Module. The Doctor's Module may then communicate any portion of this data to other systems including that physician's own billing software, or to other physician's who's service the first physician recommends (such as a specialist or the like).

It will also be noted that the Doctor Module may be configured to securely communicate directly with the Patient Module. This communication may be wired and/or wirelessly accomplished. This direct communication enables a physician's office to contact a patient regarding an upcoming appointment (send reminders and receive confirmation of expected attendance). The physician's office may also request an EDF containing particular information (such as insurance information) which the physician's office may subsequently verify, such as for example in the manner described above.

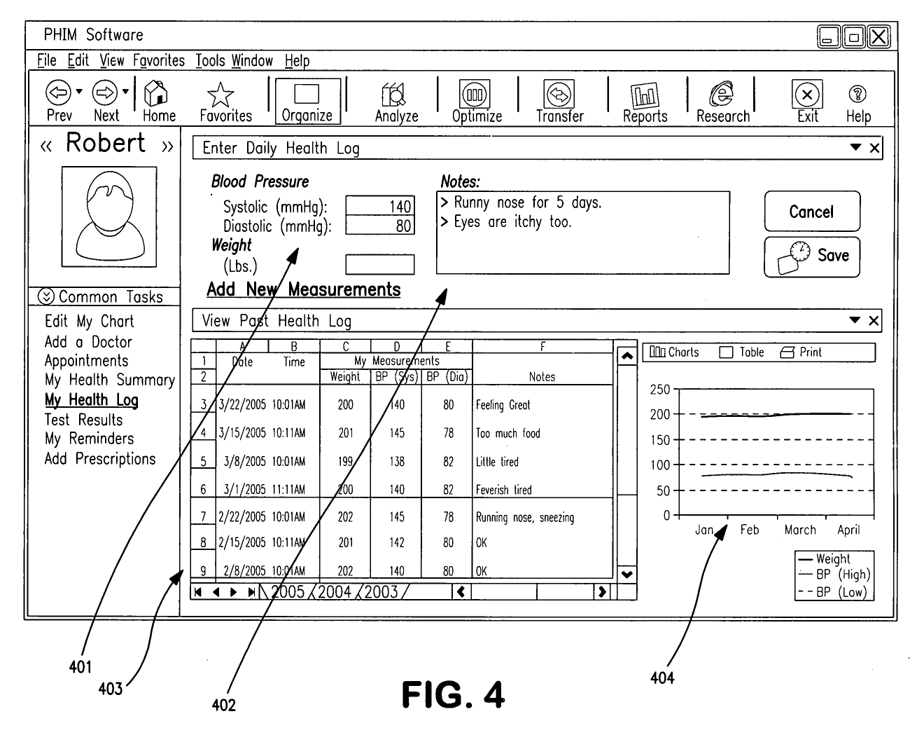

In FIG. 4, the diagram illustrates one exemplary configuration of a software user interface facilitating user tracking of healthcare data relevant to analyzing the health of the user or another party. This healthcare data can include but is not limited to, diagnostic data such as blood pressure, blood sugar level, mood and weight; healthcare expenditure data; and event data such as doctor visits and medication taken (collectively “Healthcare Data”).

The User may be provided with an interface (not shown) into which he/she will be prompted to enter certain Healthcare Data. The interface provides for example a space for the User to enter the information directed to, e.g., general characteristics such as name, height, weight, known allergies, etc. The interface will also provide a space for the User to enter more specific information such as insurance carrier information and social security number. The interface may implement dynamic color coding or another visual or audible mechanism to alert a User to the presence of required fields as he enters Data. For example, certain fields such as those necessary to verify insurance data may be written in red. Because different insurance data silos have different informational requirements, the mandatory fields highlighted on the User interface will be adapted to highlight those that are required for the User's particular insurance company entry.

The user interface provides a means for the User to enter Healthcare Data 401, related notes 402, a means for the User to view previously entered Healthcare Data 403 and a means for the User to view a graphical representation of selected Healthcare Data that has already been entered into the software 404. It will be apparent to one skilled in the art that other Healthcare Data and methods of capturing and displaying Healthcare Data may be integrated without materially departing from the principles taught herein, such as through wired or wireless connection to and receipt of information from measuring devices. It should be further noted that the interface is adapted to accept input of and provide display of multiple measurements within a given Healthcare Data category to enable the user to track information necessary to use the Healthcare Data to analyze historical trends in the Healthcare Data or parts thereof.

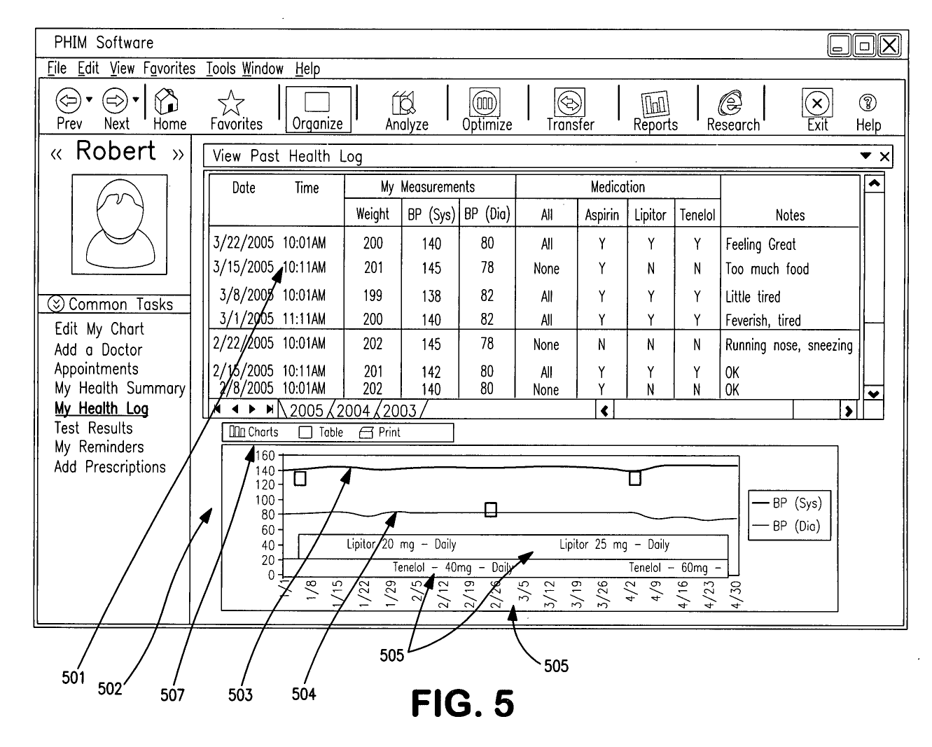

In FIG. 5 the diagram illustrates an exemplary configuration of a software user interface facilitating user visualization and analysis of the relationships between various elements of Healthcare Data. The user interface provides a means for the user to view individual Healthcare Data entries 501. The user interface also provides a means for the user to view a graphical representation of the tracked Healthcare Data 502 and to configure the appearance and composition of said graphical interface 507. Within the graphical interface, in the exemplary configuration, with respect to a specific individual's Healthcare Data, variables such as the individual's systolic blood pressure reading 503, diastolic blood pressure reading 504, and medication taken 505. Note that in the exemplary configuration, each data point is represented along a common scale of measurement, the date on which the measurement was taken or the medication taken 506.

By juxtaposing multiple Healthcare Data types on the same scale, the software enables users to analyze trends in the data both individually and in relation to changes in other Healthcare Data types. In the exemplary implementation of this teaching, a doctor or other healthcare professional can pre-define a set of patient health benchmarks (that are either unique to a given patient or that represent the “best-practice” for a given patient or patient condition type) incorporating various health metrics (for example, taking certain measurements (blood pressure, blood sugar, etc. . . . ) at certain times and taking certain medication at certain times) and pass them to the patient for uploading in the patient module. The patient subsequently inputs data (or data is inputted into the Patient Module for the patient either manually or automatically from measurement devices) and the patient's actual health metrics are compared with the benchmarks defined by the doctor (or other healthcare professional). The results of this comparison can be displayed in tabular form or in the integrated display described above or recorded for subsequent review and also can be used to trigger additional actions such as sending notification to a defined party (for example a doctor or patient or another authorized party). In addition, the results of the comparison can be used in conjunction with a treatment database or algorithm to generate customized care instructions to assist the patient in conforming their actual healthcare statistics to the pre-set benchmarks.

It will further be apparent to one skilled in the art that the specific Healthcare Data types, the layout and composition of the comparison table, methods of configuring of the table, alternate configurations of the table and user interface and methods of displaying the data may all be amended or augmented without departing from the principles taught herein.

It will be recognized that while certain aspects of the invention are described in terms of a specific design examples, these descriptions are only illustrative of the broader methods of the invention, and may be modified as required by the particular design. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

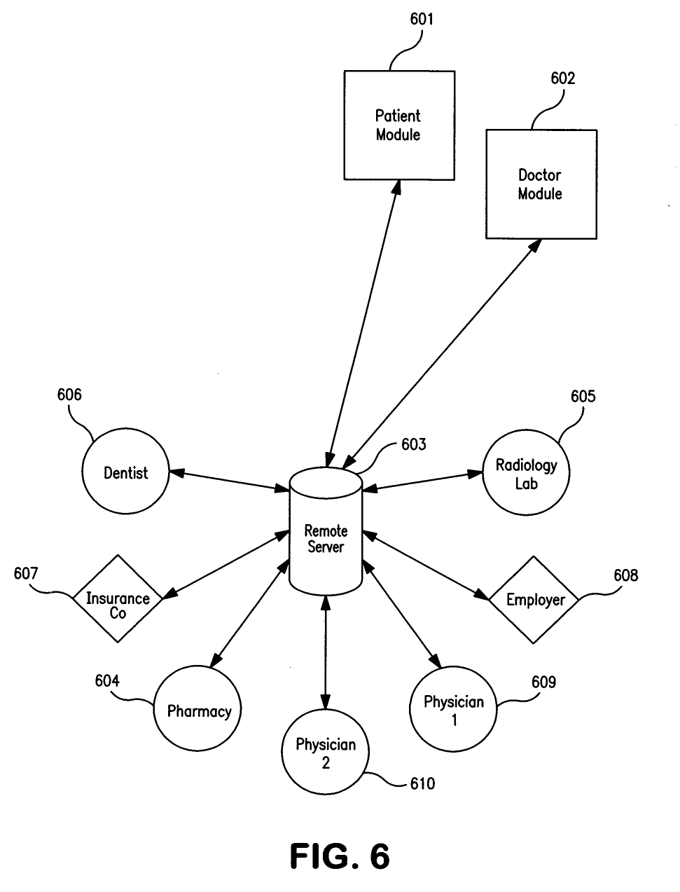

In FIG. 6 the diagram depicts a representative configuration incorporating the features of the fifth aspect of the instant invention. The user (not shown) inputs a request for data into the Patient Module 601 or the Doctor Module 602. The information the user inputs includes information designating the Data silo from which the user requires Data. Alternatively, the Patient Module 601 or the Doctor Module 602 may incorporate functionality enabling the user to designate a Data silo from which a Data request should be submitted or the Patient Module 601 or the Doctor Module 602 may incorporate logic enabling them to identify and rank the most likely Data silos from which the Data may be requested.

The Patient Module 601 or the Doctor Module 602 then transmits the query to a server 603 configured with software designed to work in conjunction with the Patient or Doctor Module (the “Remote Server”) in an encrypted format or optionally, in an unencrypted format. Software on the Remote Server 603 incorporates functionality enabling it to communicate with the Patient Module 601 and the Doctor Module 602 on the one hand, and with various Data silos on the other hand. Examples of Data silos the Remote Server 603 might communicate with include, but are not limited to, Data silos maintained by a pharmacy 604, a radiology lab 605, the user's dentist 606, the user's health insurance company 607, the user's employer 608, the user's primary care provider 609 and the user's specialist 610.

With respect to the Data silos, because the Data silos exist in a variety of forms, many of which require that the queries be formatted in a specific manner, the Remote Server 603 incorporates functionality enabling it to format the queries received from the Patient Module 601 or the Doctor Module 602 in a wide variety of formats each tailored to the requirements of the targeted Data silo. The Remote Server 603 is configured to allow the user to easily add, delete and modify its existing database of query formats enabling it to be quickly adapted to communicate with additional Data silos. Alternatively, the Remote Server 603 can incorporate functionality allowing it to send test queries to targeted Data silos and to discover whether existing communication protocols already known to the Remote Server 603 may be employed to communicate with the newly targeted Data silos.

By acting as a centralized intermediary that knows how to connect to various data silos, the exemplary Remote Server 603 of the illustrated embodiment provides an ability to rapidly expand or update the ability of multiple instances of the Doctor's Module to connect to various data silos. Thus, the number of data silos a Doctor's Module may communicate with may be increased without having to update each Doctor's Module individually. Rather, by connecting to the Remote Server 603, a Doctor's Module will be permitted to access any data silo available to the Remote Server 603.

It should be noted that the Data silo connectivity disclosed in the Remote Server 603 above may be incorporated directly into the Patient Module 601 and Doctor Module 602. In such event, the Patient Module 601 and Doctor Module 602 may be configured to route Data silo queries either through the Remote Server 603 to the Data silo in question or directly to the Data silo from the Patient 601 or Doctor Module 602. Alternatively, the Patient 601 and Doctor Modules 602 may be configured to connect directly to an alternate server (not shown) that is configured to act as a gateway enabling the Patient 601 and Doctor Modules 602 to access required Data silos known to or secured by the alternate server. Further, the Remote Server 603 may be adapted to connect to an alternate server that is configured to act as a gateway enabling the Remote Server 603 to access required Data silos known to or secured by the alternate server.

Additional aspects of the invention disclosed within this teaching are:
A remote server used in the healthcare space to act as a common query interface such that Patient Module and Doctor Module can connect to the remote server from time to time that does not itself store data (improving security and reducing the cost of securing the server) but that instead acts as a trusted arbiter of the communication between the Patient Module and/or Doctor Module and a Data silo or multiple Data silos.
A remote server used in the healthcare space to act as a common query interface such that Patient Module and Doctor Module can connect to the remote server from time to time that does not itself store data (improving security and reducing the cost of securing the server) but that instead acts as a trusted arbiter of the communication between a Patient Module and other Patient Modules, between a Patient Module and a Doctor Module, or between the Doctor Module and another Doctor Modules.
A transmission apparatus whereby a Patient Module can transfer Data in electronic formats directly to another Patient Module or directly to a Doctor Module using a USB Flash drive or email as the method of transmission. It will be apparent to one skilled in the art that other methods of transmission including but not limited to, Bluetooth, WiFi, RFID, Smart (IC) Cards and IrDA may be substituted without departing from the principles taught herein.
A method of enabling the Doctor Module to capture data from multiple Patient Modules, aggregate the captured data and either analyze it locally or share it with a remote server or servers enabling the remote analysis of such data. If required, certain identifying elements of the data set (such as patient identity) can be removed from the data set enabling compliance with applicable privacy requirements. In one exemplary application, selected patient health statistics are transferred by multiple Patient Modules to a Doctor Module. The Doctor Module aggregates the health statistics and removes patient specific identification details from the data. The Doctor Module then uploads the aggregated, anonymized data to a secure server where the data is compared with similarly aggregated and anonymized data provided by other physicians (the “Comparison Server”). Where necessary, algorithms are employed to adjust the data to match population characteristics and perform other statistical functions as necessary to maximize the statistical relevance of the data comparisons. Results of the comparison are translated by other algorithms into notices and/or guidance enabling the physician to identify where his or her patient data differs in positive or negative ways as against the population of patients represented by the aggregated data that has been uploaded to the Comparison Server. This can be used, for example, to advise the physician on steps to be taken to better conform his or her treatment practices with identified “best practices” or to enable the physician to identify and analyze trends in his or her patient pool (for example, a better or worse patient reaction to a certain treatment or medication regimen). Alternatively, the Doctor Module can retain the patient data (to avoid sharing the data with the Comparison Server) and instead merely download comparison data from the Comparison Server and perform the analysis directly.
   Further, Patient Modules can themselves perform functions similar to the Doctor Modules in this regard. In this event, the Patient Modules will either transfer data concerning the patient (suitably anonymized as required) to a Comparison Server adapted to accept non-aggregated data. The Comparison Server can then perform the aggregation and analysis function and return to the Patient Module the notices and recommendations resulting from the analysis or alternatively, the Patient Module may not share patient specific data with the Comparison Server but instead simply download appropriate statistical information from the Comparison Server and then perform its own analysis comparing the aggregated Comparison Server data with the patient's own healthcare statistics.

It should be noted that the Patient Module, Doctor Module and Comparison Server represent arbitrary divisions of functionality that are created for convenience of description only. It will be apparent to one skilled in the art that consolidating some or all of the functionality described with respect to the Patient Module, Doctor Module and Comparison Server into other combinations of functionality or within one or more alternate applications may be done without departing from the novel principles taught herein.
Incorporation of software algorithms into the Patient Module enabling the user to analyze healthcare statistics and treatment or healthcare expenditure specifics. In one exemplary implementation, the Patient Module incorporates functionality enabling it to compare the healthcare statistics of the user with constantly updated statistics derived from population, best practice or other data models and through that comparison derive treatment advice (such as, in the case of high blood pressure, warnings to reduce salt intake or contact a doctor) that is provided to the user in both text based and graphical formats. The Patient Module also incorporates additional functionality enabling a user that has been prompted to contact a certain type of doctor to choose from a listing of doctors that has been assembled by analyzing the user's health insurance particulars and other relevant data and to even obtain driving directions to visit that doctor. In another exemplary implementation, the Patient Module incorporates software algorithms enabling it to capture and display the user's health insurance details from Data silos and to propose changes to optimize various aspects of the health insurance coverage (including but not limited to cost, scope of services covered, etc. . . . ) by comparing those details against user configured prioritization criteria and external databases of competing options available to the user.

It should be further noted that while for the purposes of convenience, in the instant teaching, the examples of Data silos have been limited to certain specific elements of the healthcare ecosystem such as doctors, labs, hospitals, employers and patients, this is not meant to imply that the scope of data sharing would be limited only to these Data silos. Indeed, sharing across other Data silos such as other health facilities (nursing homes, senior care centers, convalescent homes, long term care facilities, etc. . . . ), other healthcare services providers and other participants in the healthcare ecosystem (public and private legal guardians of patients, family members of patients, research study participants, etc. . . . ) are all within the scope of the instant invention. Further, it will be apparent to one skilled in the art that the principles taught herein, may be broadly applied to contexts other than the direct healthcare ecosystem and may extend to other contexts in which it is desired to share data in electronic formats with participants in the healthcare ecosystem.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A method of analyzing data in support of user decision-making and optimization, wherein said method comprises:
entering said data into a data collection entity;
securely storing an electronic copy of said data on said data collection entity; and
providing a method for the retrieval, display and analysis of said data.

2. The method of claim 1, wherein said data comprises healthcare-related data, and said act of entering said healthcare-related data is accomplished by manual entry of said data via a user interface.

3. The method of claim 1, wherein said data comprises healthcare-related data, and said act of entering said healthcare-related data is accomplished by communication of said data collection entity with a healthcare-related data measuring device.

4. The method of claim 1, wherein said data collection entity comprises a portable storage device.

5. The method of claim 1, wherein said data comprises healthcare-related data, and said collection entity comprises a hard disk drive of a healthcare professional-maintained terminal.

6. The method of claim 1, wherein said data collection entity comprises a data silo.

7. The method of claim 6 wherein said act of retrieving said data from said data silo is accomplished by establishing a connection to a remote server, said remote server adapted to route inquiries to said data silo.

8. The method of claim 1, wherein said data comprises:
patient-specific healthcare-related data; and
healthcare benchmark information, or health metrics data, determined by a healthcare professional;
wherein said healthcare benchmark information, or health metrics data, is utilized for comparison to said patient-specific healthcare-related data.

9. The method of claim 1, further comprising:
establishing a secure connection to a remote entity; and
securely transmitting at least a portion of said healthcare-related data to selected recipients via said secure connection to said remote entity.

10. A storage apparatus, comprising a computer-readable storage medium adapted to store a computer program thereon, said computer program adapted to enable a user to:
acquire healthcare-related data;
store said healthcare-related data;
view said healthcare-related data;
analyze said healthcare-related data via at least one analysis tool; and
supplement said healthcare-related data with additional informational elements.

11. The apparatus of claim 10, further comprising a computer program further adapted to securely communicate with a remote entity to enable at least one of secure transmission and acquisition of said healthcare-related data.

12. The apparatus of claim 11, further comprising a computer program adapted to:
combine healthcare-related data from a first entity with healthcare-related data from a second entity; and
utilize analytical tools to compare said healthcare-related data from said first and second entities.

13. The apparatus of claim 10, further comprising a computer program adapted to:
combine healthcare-related data from a first entity with healthcare-related data from a second entity; and
utilize analytical tools to compare said healthcare-related data from said first and second entities.

14. The apparatus of claim 11, further comprising a computer program adapted to:
record information regarding the location and nature of said remote entity; and
utilize said recorded remote entity information to enable a user to request and receive updated healthcare-related data.

15. The apparatus of claim 10, wherein said enabling said user to acquire said healthcare-related data comprises enabling said user to manually enter said healthcare-related data via a user interface.

16. The apparatus of claim 15, wherein said user interface is adapted to perform dynamic color coding to highlight mandatory information fields.

17. The computer-readable media of claim 10, wherein said healthcare-related data comprises:
at least one set of patient-specific healthcare-related data; and
a first set of healthcare benchmark or health metrics data;
and wherein said computer program is further adapted to enable a user to:
share said healthcare benchmark or health metrics data;
display said first set of healthcare benchmark or health metrics data against said patient-specific healthcare-related data.

18. The apparatus of claim 17, further comprising a computer program further adapted to display said healthcare benchmark or health metrics data and said patient-specific healthcare related data on a single display incorporating common scale of measurement.

19. A portable storage device for capturing and securely storing healthcare-related data in support of analysis and patient decision-making, comprising:
a security element adapted to substantially frustrate unauthorized access to said data;
a receiving element adapted to capture said healthcare-related data and authenticate said data as being from a trusted provider and unmodified;
a storage element adapted to record said captured healthcare-related data; and
a communication element adapted to establish secure communication with a remote entity.

20. The apparatus of claim 19, wherein said remote entity comprises a data silo.

21. The apparatus of claim 19, wherein said remote entity comprises a remote server, said remote server adapted to communicate with at least one data silo containing said healthcare-related data.

22. The apparatus of claim 19, wherein said remote entity comprises a computer adapted to run a computer program, said computer program adapted to retrieve said healthcare-related data from said portable storage apparatus and to enable a user to view and analyze said healthcare-related data.

23. The apparatus of claim 22, wherein said remote entity comprises a healthcare professional maintained terminal computer.

24. The apparatus of claim 19, wherein said portable storage apparatus comprises a USB flash key adapted to insert into a USB port of said remote entity.

25. The apparatus of claim 19, wherein said portable storage apparatus further comprises:
a hard disk drive element adapted to store a computer program, said computer program adapted to enable a user to analyze said healthcare-related data;
a display element, said display element adapted to display at least a portion of said healthcare-related data; and
a user interface, said user interface adapted to permit a user to:
manually enter at least portions of said healthcare-related data; and
utilize analysis tools to analyze at least portions of said healthcare-related data.

26. The apparatus of claim 19, wherein said communication element comprises a component necessary for wireless connection to said remote entity.

27. A healthcare professional maintained terminal comprising:
a security element adapted to disallow unauthorized access;
a receiving element adapted to capture healthcare-related data and authenticate said data as being from a trusted provider and unmodified;
storage device adapted to store said captured healthcare-related data;
a computer program, said computer program adapted to enable a user to analyze said healthcare-related data;
a display element, said display element adapted to display said healthcare-related data;
a user interface, said user interface adapted to permit a user to utilize analysis tools to analyze said healthcare-related data; and
a communication element adapted to enable secure communication between said terminal and a remote entity.

28. The terminal of claim 27, wherein said remote entity comprises a data silo.

29. The terminal of claim 27, wherein said remote entity comprises a remote server, said remote server adapted to communicate with at least one data silo containing said healthcare-related data.

30. The terminal of claim 29, wherein said healthcare-related data comprises patient insurance information and wherein said remote server is adapted to communicate with an insurance data silo and allow said insurance data silo to send verification of said patient insurance information.

31. The terminal of claim 30, wherein said patient insurance information and said verification of said patient insurance information are retained by said terminal, and said communication element enables secure communication of said patient insurance information and said verification of said patient insurance information between said terminal and a remote entity.

32. The terminal of claim 27, wherein said remote entity comprises a portable storage device.

33. The terminal of claim 32, said terminal further being adapted to:
request patient-specific healthcare-related data from said portable storage device;
receive said patient-specific healthcare-related data; and
process said patient-specific healthcare-related data.

34. The terminal of claim 33, wherein said patient-specific healthcare-related data requested comprises confirmation of an appointment, and said processing of said confirmation of an appointment comprises recording the status of the appointment.

35. The terminal of claim 34, wherein said patient-specific healthcare-related data requested comprises patient insurance information, and said processing of said patient insurance information comprises sending said patient insurance information to a remote server, said remote server being adapted to communicate with an insurance data silo and enable said silo to send verification of said patient insurance information.

36. The terminal of claim 27, wherein said user interface is adapted to enable a user to manually enter said healthcare-related data.

37. A system for the secure transmission and storage of healthcare-related data, said system comprising:
an entity adapted to maintain said healthcare-related data in electronic form;
at least one portable storage device, said portable storage device adapted to securely communicate with said entity to receive, store, and securely transmit said healthcare-related data.

38. The system of claim 37, wherein said secure communication between said portable storage device and said entity is accomplished via at least a secure wireless connection.

39. The system of claim 38, wherein said entity comprises a data silo.

40. The system of claim 39, wherein said data silo and said at least one portable storage device are adapted to communicate through the utilization of a remote server.

41. The system of claim 37, wherein said entity comprises a healthcare facility terminal.

42. A method of doing business, said method comprising:
making healthcare-related data available to a patient; and
enabling a patient to utilize a portable storage device adapted to:
receive said healthcare-related data;
store said healthcare-related data; and
analyze said healthcare-related data.

43. The method of claim 42, wherein said healthcare-related data is made available to said patient by permitting said patient to access a remote entity containing said healthcare-related data.

44. The method of claim 43, wherein said remote entity comprises a data silo.

45. The method of claim 44, wherein said access to said data silo is accomplished via routing through a remote server.

46. The method of claim 42, wherein said remote entity comprises a terminal maintained and operated by a medical facility.
